(19) United States
(12) Patent Application Publication
(10) Pub. No.: US 2022/0398769 A1
(43) Pub. Date: Dec. 15, 2022

(54) RECOVERING ALIGNMENT GRIDS

(71) Applicant: Hewlett-Packard Development Company, L.P., Spring, TX (US)

(72) Inventors: Stephen Pollard, Bristol (GB); Robert Ulichney, Stow, MA (US); Matthew D. Gaubatz, Seattle, WA (US)

(73) Assignee: Hewlett-Packard Development Company, L.P., Spring, TX (US)

(21) Appl. No.: 17/770,071

(22) PCT Filed: Oct. 31, 2019
(86) PCT No.: PCT/US2019/059087

§ 371 Date: Apr. 19, 2022

(51) Int. Cl. G06T 7/73; G06V 10/22; G06V 10/74; G06V 10/44; G06T 5/20

(52) U.S. Cl. CPC G06T 7/73; G06V 10/225; G06V 10/761; G06V 10/44; G06T 5/20

(57) ABSTRACT

In some examples, a method for recovering an alignment grid comprising multiple fiducial dots, the alignment grid for resolving multiple data dots, comprises determining a respective local structure within a local region around each fiducial dot and each data dot, and generating a connected subset of local structures to form a candidate alignment grid.

### BACKGROUND

Dot patterns can be used to encode information. For example, a dot pattern can be provided on a surface of an object or as part of a printed image. Dot patterns can comprise a data encoding component interspersed within a registration component that enables the data component to be decoded.

### BRIEF DESCRIPTION OF THE DRAWINGS

Various features of the techniques of the present application will become apparent from the following description of examples, given by way of example only, which is made with reference to the accompanying drawings, of which:

FIG. 1 is a schematic representation of an exemplary dot pattern according to an example;

FIG. 2 is a flowchart of a method for recovering an alignment grid according to an example;

FIG. 3 is a schematic representation of a portion of a dot pattern image according to an example;

FIG. 4 is a schematic representation of a portion of a dot pattern image according to an example; and

FIG. 5 is a schematic representation of an apparatus for recovering an alignment grid in part of an image of a surface according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

A dot pattern can comprise multiple dots that form a data encoding component composed of data dots interspersed within a fiducial component composed of fiducial dots. The fiducial dots define an alignment grid that enables the data dots to be decoded. That is, the fiducial dot component of the pattern can comprise a regular grid pattern of fiducial dots that can be used to resolve alignment of the data carrying portion of the pattern. The fiducial dots may themselves be subject to some perturbations, i.e., variations in the positions or renderings of the dots. The fiducial dots and the data dots may form a complete or partial grid pattern. In an example, an alignment grid may serve a dual purpose inasmuch as it forms a reference grid pattern whilst also encoding data by virtue of e.g. perturbations in some of the fiducial dots. Accordingly, in a pattern comprising data dots and fiducial dots, some or all data dots can be composed of a subset of fiducial dots that have been spatially perturbed, or subject to some other modification to encode data (e.g. shaped or profiled or provided as a halftone structure for example).

A dot pattern is, in general, composed of dots that are of small size and which form a sparse dot pattern such that the pattern has minimal visual impact while still being detectable in images captured of the surface or printed object upon which the dot pattern is provided. Recovery of an alignment grid to determine the relative positions of data dots to enable data decoding can be complex and computationally expensive.

According to an example, there is provided a method for recovering an alignment grid comprising multiple fiducial dots that performs robustly and efficiently.

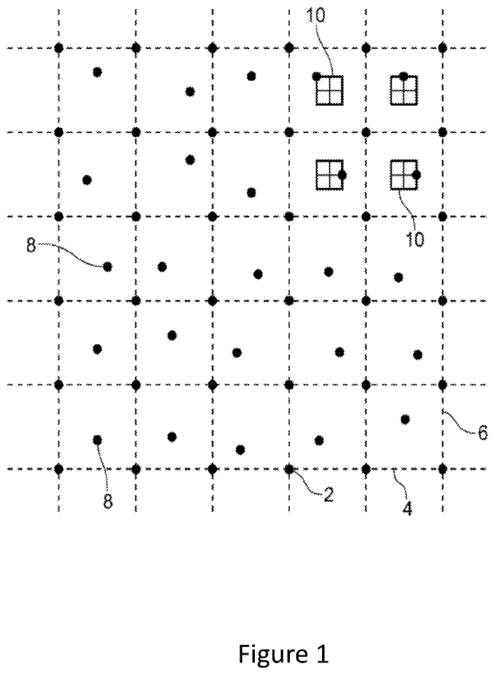

FIG. 1 is a schematic representation of an exemplary dot pattern according to an example. A regular alignment grid is formed from a plurality of fiducial dots 2. In the example of FIG. 1, the fiducial dots are aligned along virtual mutually orthogonal axes 4, 6, which form virtual square unit cells. Other alignments are, of course, possible leading to different alignment grid patterns.

Within each individual unit formed by the fiducial dots 2 a further data dot 8 may be provided. In the example of FIG. 1, a data dot 8 can be placed at any one of nine vertices of a 3×3 virtual array 10. The location of a data dot 8 within each unit of the alignment grid thus defines one of nine possible data symbols. Of course, it is perfectly feasible for the location of a data dot to be provided at other positions within the alignment grid defined by the fiducial dots 2 and/or for more than one data dot to be provided within one unit.

When a dot pattern, such as that described with reference to FIG. 1 for example, is imaged with a field or view orthogonal to the plane of the surface upon which the pattern is presented, it is a relatively straightforward task to identify the alignment grid. However, when subject to perspective distortion, such as that induced by an imaging system viewing the pattern at an angle, a number of possible alternative interpretations of the alignment grid can be formed, thereby increasing the difficulty in detecting the correct alignment grid.

According to an example, there is provided a method for recovering an alignment grid comprising multiple fiducial dots, the alignment grid for resolving multiple data dots, in which a respective local structure within a local region around each fiducial dot and each data dot is determined. A connected subset of local structures is determined in order to form a candidate alignment grid, and the candidate alignment grid is used to generate a mapping to recover the alignment grid.

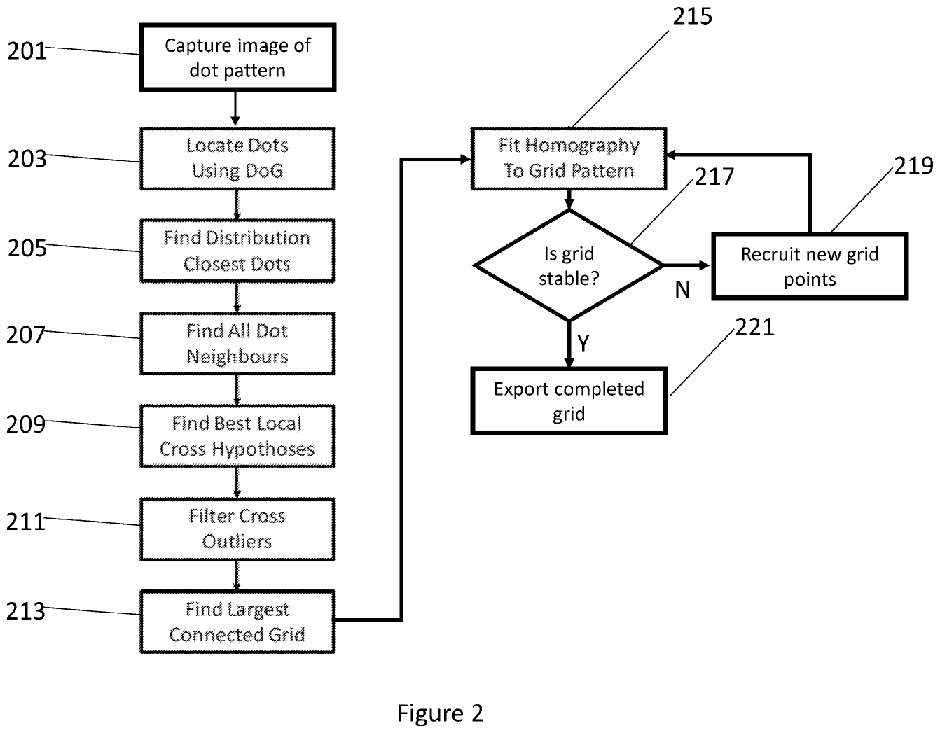

FIG. 2 is a flowchart of a method for recovering an alignment grid according to an example. According to an example, a grid can be thought of as a sequence of local sub-grid structures, such as crosses for example, that are connected together. Imposing constraints on local sub-grid structures based on e.g. orientation, size and skewness enables quick determination of a local grid structure that can be extended out to provide a global structure representing an alignment grid. In an example, a constraint can include a measure of the closeness or proximity of the dots making up the regular alignment (fiducial) grid structure. In an example, a limiting dot pitch, which relates to a limiting distance of an imaging structure such as a camera from a document or surface for example, can be used. Beyond such a limit, precision may be compromised making it difficult to determine the relative position of coded (data) dots with respect to the alignment grid.

In a dot pattern according to an example, a (printed or deposited) dot spacing can typically be 32 pixels (assuming, for example, that a document or image comprising a dot pattern is printed or presented at a resolution of around 600 dpi). There are around 5000 or so pixels across a 600 dpi letter sized page that can be imaged in an HD resolution (e.g. resolution corresponding to 1080P). Thus, the scaling factor is approximately 1:5 and so, in an example, a minimum (print) spacing (i.e. a limiting dot pitch) will be around 6 pixels.

According to an example, a method for recovering an alignment grid does so on a local scale before extending to a global scale. Referring to FIG. 2, in block 201, an image of a dot pattern is captured. For example, an imaging structure of a smart phone or digital camera may be used to capture an image of a dot pattern provided on the surface of an object, which may be an additively manufactured object for example, or on the surface of a printed document or image. In an alternative example, image data representing a previously captured image may be provided at block 201.

In block 203, dots within the image are enhanced and identified. In an example, this task can be performed by applying a band pass filter, such as a Difference of Gaussian (DoG) operator, that amplifies the presence of dots at an appropriate scale. For an HD resolution image for example, a high frequency Gaussian filter can have a sigma (standard deviation) of 1.0 pixel and a low frequency filter can have a sigma of 6.0 pixels, the difference of the so filtered images forming the DoG filtered image. Alternatively, the filters themselves can be differenced to produce a single DoG filter that can be applied to the image directly but in practice this is less efficient as it does not utilize the separable property of the individual Gaussian filters that enables the 2D N×N filter to be reduced to the application of a pair of 1D 1×N filters in orthogonal directions. In an example, dot location proceeds by determining local peaks and/or their inverse in a DoG filtered image. Non-maximum suppression can be used to ignore weaker dot features. This results in a representation of the position of dots relative to the originating image that can be processed in order to determine the alignment grid and thus decode any information encoded by the data dots of the pattern in question.

In block 205, a distribution of closest dot distances (that are larger than the limiting dot pitch described above) is determined and used to define a local region within which potential sub-grid structures, e.g. crosses, around each dot are selected. That is, in block 207, for each dot (data and fiducial) in a dot pattern, as determined above, the distance to its closest neighbour is determined. The set of distances thus collected from each dot in the pattern forms a distribution. In an example, the radius of the local region is defined as 3× the 80th percentile of this distribution, ignoring those distances that are less than the limiting dot pitch. Within this radius potential sub-grid structures around each dot are selected. Other measures to define a radius of the local region are possible, including ones based on the distribution noted above or ones selected without recourse to such a distribution.

Note that, other local sub-grid structures (other than crosses) can be used. That is, it is possible to consider alternative elemental structures other than crosses that compose a grid. For example, elemental triangles or squares can be used. Crosses are, however, uniquely defined with respect to the context dot.

Within the local region, local sub-grid structure finding determines the best single sub-grid structure (e.g. cross) in the neighbourhood around each single context dot (which is the dot that defines the position of the local region under consideration). In an example, in block 209, this proceeds by finding north/south candidates and east/west candidates that are approximately orthogonal (within around 5 degrees). In an example, north/south point candidates are within 45 degrees (and possibly less) of the north and south vertical directions in the image with respect to the dot under consideration. In an example, to be a valid pair the three dots of a north south pair including the central context dot (around which the local region is developed) will be approximately colinear. Furthermore, north/south dot pairs will be substantially equally spaced either side of the context dot dependent on a percentage length difference (longer to shorter), which may be set at 10% for example. This range relates to a slope difference in the plane of the surface from which the image is captured of approximately 25 degrees (i.e. arccos of 0.9 assuming orthogonal projection). East/west pairs are found in a similar way. In an example, as well as being roughly orthogonal north/south and east/west pairs should be of similar lengths as determined by the same percentage length threshold as described above (although it may differ if desired). In an example, in ambiguous cases where multiple crosses satisfy these conditions within the neighbourhood of a context dot the one of smallest size is chosen. Alternatively, it is possible to entertain multiple candidate crosses at each location leaving the resolution of the ambiguity until later in the process.

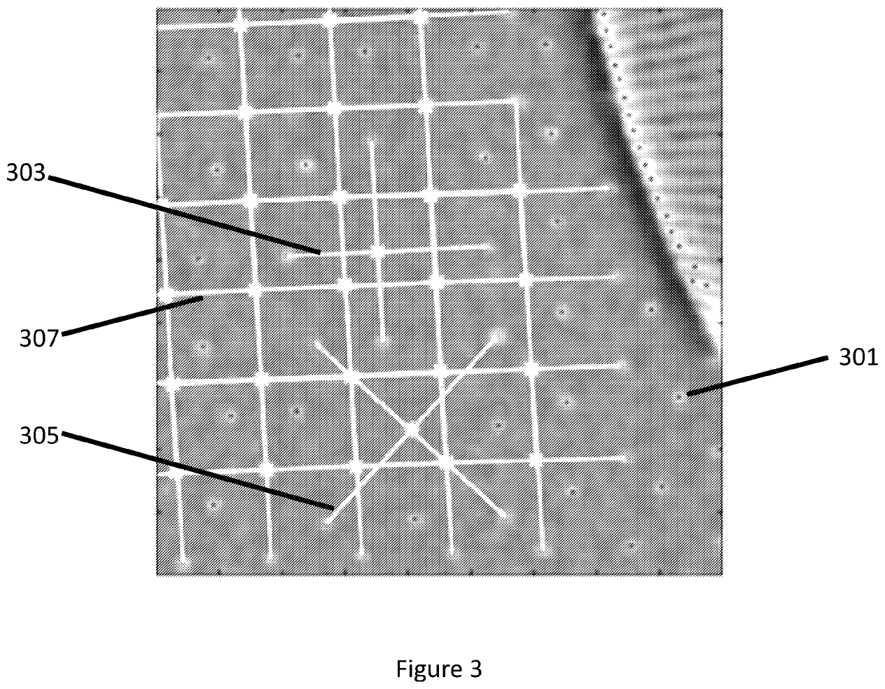

FIG. 3 is a schematic representation of a portion of a dot pattern image according to an example. In the example of FIG. 3, all the crosses found within the selected region that satisfy a set of local constraints are shown. That is, each dot 301 in a local region, as determined based on the distribution of dot nearest neighbours as described above, is used to determine the presence of a local sub-grid structure, such as a cross as depicted in FIG. 3. For each local region around a dot one such sub-grid structure is selected. In the example of FIG. 3, multiple such sub-grid structures that have been determined around multiple dots are depicted.

In an example, the pool of recovered crosses is considered en masse to recover statistical ranges of sizes and orientations based on percentiles. That is, the size of crosses can be used to generate a distribution, or the orientation of crosses can be used to generate a distribution. In some examples, a distribution can be generated using both size and orientation.

In an example, the 15.865th, 50th and 84.135th percentiles of a distribution as described above are approximated as these correspond to one standard deviation either side of the mean of a normal distribution. A range 3 times this is then used to identify inliers and outliers, that is sub-grid structures that form part of a candidate alignment grid, and those that should not. Thus, in block 211 outliers can be filtered out (i.e. not considered going forwards). In block 213 the best candidate grid can then be identified as the largest connected subset of crosses (for example).

With reference to FIG. 3, multiple ones of the crosses (the inliers) of FIG. 3 form a structure 307, whilst crosses 303 and 305 (outliers) do not form part of this structure. Thus, based on a distribution of orientation for example, as described above, crosses 303 and 305 are classified as outliers compared to the set of crosses forming the connected subset of crosses 307.

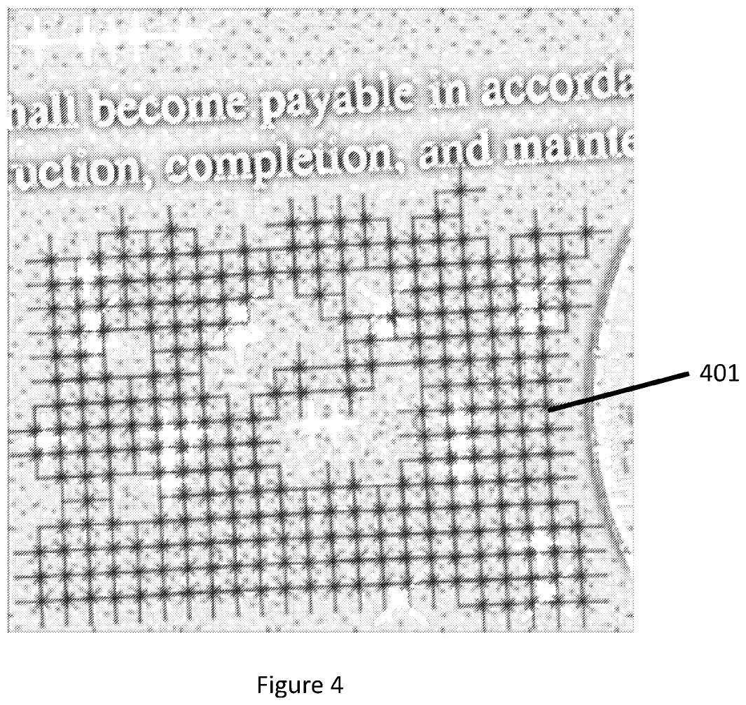

FIG. 4 is a schematic representation of a portion of a dot pattern image according to an example. FIG. 4 shows an extended view of a portion of an image, showing a representation of a candidate alignment grid 401 according to an example, which presents itself as a connected subset of crosses (note that FIG. 3 shows a sub portion of FIG. 4, specifically the lower right-hand corner of FIG. 4). Some gaps are present as a result of no appropriate sub-grid structure being found at the points in question.

The candidate grid 401 is iteratively grown and new candidate grid-points added. In an example, in block 215, this is done by fitting a planar homography representing the transformation of notional grid indices to the image dot locations associated with the relevant grid-points of the candidate grid to define a first representation of an alignment grid.

That is, in an example, a homography is used to map between reference grid coordinates and the positions of the projection of that grid into the image. Thus, once a number of correspondences between reference grid coordinates and image locations (that is, the locations of fiducial dots) are known, the rest can be inferred.

The grid recovered from the homography can be extended in all directions and used to search for supporting grid points. The new points can then be used to refine the homography. The grid can be considered stable when there are no new supporting points to recruit. Thus, in block 217, a determination is made as to whether the determined grid is stable by determining if there are new grid points that have not been considered previously. If the grid is stable, the alignment grid is provided in block 221. Otherwise, in block 219, new grid points are used to refine the homography.

Once the alignment grid is complete the positions of data dots relative to the alignment grid can be determined. Note that, according to an example, the alignment grid can be identified without using all the fiducial dots. Accordingly, decoding of data dots can proceed using the alignment grid that has been identified in block 221. In some examples, the position of a data dot can be determined by computing the centroid of a possibly segmented object in the region of the data dot, or by computing a pixel-based distance, such as mean-squared error, between the pixels in that region and pixel models representing dots in different positions. In other examples, measurements of the quality of a determined data dot position can be used as an indicator of the quality of the fiducial dot alignment scheme, which can be used to refine the alignment of the fiducial dots.

The term “dot”, as used herein, can encompass a single printed or deposited artefact, e.g. formed from a deposited droplet of a print fluid, or formed from multiple droplets, or a more complex structure, such as a halftone structure for example.

Examples in the present disclosure can be provided as methods, systems or machine-readable instructions, such as any combination of hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

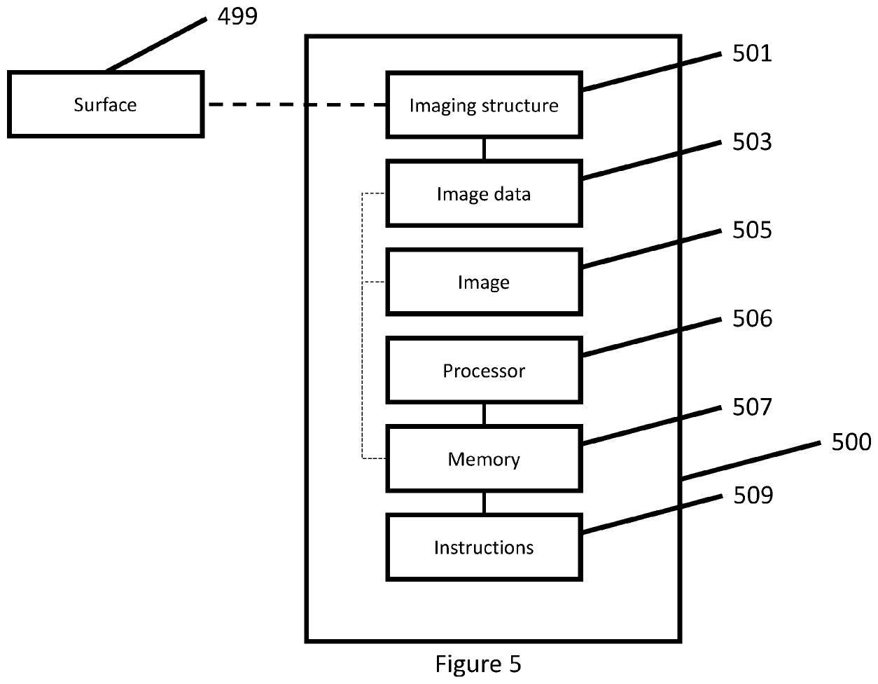

FIG. 5 is a schematic representation of an apparatus for recovering an alignment grid in part of an image of a surface according to an example. The surface 499 can be a printed document (comprising e.g. text and/or image(s)) or part of a surface of a structure, such as an additively manufactured structure for example. The surface can comprise a dot pattern, such as that described above. The apparatus 500 of FIG. 5 can be a device such a smart phone for example, or other imaging device, comprising an imaging structure 501 to generate image data 503 representing an image 505 of the surface 499. The apparatus can comprise a processor 506 associated with a memory 507. The memory 507 can comprise machine-readable instructions 509 which are executable by the processor 506. The instructions 509 can comprise instructions to filter image data representing an image of a surface encoding data using multiple data dots dispersed within an alignment grid comprising multiple fiducial dots, and generate a candidate alignment grid based on a connected subset of local structures, respective local structures recovered from the multiple fiducial dots and multiple data dots within the image.

In an example, the instructions 509 can comprise instruction to determine the position of multiple fiducial dots and multiple data dots within the image, determine a respective local structure within a local region around each fiducial dot and each data dot, generate a connected subset of local structures to form a candidate alignment grid, and generate a mapping to recover the alignment grid.

Such machine readable instructions may also be loaded onto a computer or other programmable data processing devices, so that the computer or other programmable data processing devices perform a series of operations to produce computer-implemented processing, thus the instructions executed on the computer or other programmable devices provide a operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for recovering an alignment grid comprising multiple fiducial dots, the alignment grid for resolving multiple data dots, the method comprising:
determining a respective local structure within a local region around each fiducial dot and each data dot; and
generating a connected subset of local structures to form a candidate alignment grid.

2. The method as claimed in claim 1, further comprising:
using the candidate alignment grid, generating a mapping to recover the alignment grid.

3. The method as claimed in claim 1, further comprising:
determining respective measures of the distance from each fiducial or data dot to its nearest neighbour fiducial or data dot above a threshold distance.

4. The method as claimed in claim 3, further comprising:
generating a distribution of the measures of distance; and
using the distribution, defining a radius for the local region.

5. The method as claimed in claim 1, further comprising:
generating a distribution representing a range of the sizes and/or orientations of the local structures; and
using the distribution, selecting the subset of local structures.

6. The method as claimed in claim 1, further comprising:
defining a planar homography to map grid locations of points in the candidate alignment grid to image locations of the alignment grid.

7. The method as claimed in claim 1, further comprising:
applying a band pass filter to an image; and
determining the position of local peaks and/or their inverse to identify the positions of the multiple fiducial dots and the multiple data dots within the image.

8. Apparatus for recovering an alignment grid in part of an image of a surface, the apparatus comprising:
an imaging structure to generate image data representing the image; and
a processor to:
determine the position of multiple fiducial dots and multiple data dots within the image;
determine a respective local structure within a local region around each fiducial dot and each data dot; and
generate a connected subset of local structures to form a candidate alignment grid.

9. The apparatus as claimed in claim 8, the processor further to:
filter the image data using a band pass filter to determine the position of local peaks and/or their inverse in the image whereby to identify the positions of the multiple fiducial dots and the multiple data dots within the image.

10. The apparatus as claimed in claim 9, the processor further to:
generate a planar homography to map grid locations representing points of the candidate alignment grid to points on the alignment grid; and
recover a first representation of the alignment grid using the planar homography.

11. The apparatus as claimed in claim 10, the processor further to:
determine the presence of supporting grid points within the first representation of the alignment grid.

12. The apparatus as claimed in claim 11, the processor further to:
use supporting grid points to refine the planar homography.

13. A machine-readable storage medium encoded with instructions for recovering an alignment grid, the instructions executable by a processor of an apparatus to cause the apparatus to:
filter image data representing an image of a surface encoding data using multiple data dots dispersed within an alignment grid comprising multiple fiducial dots; and
generate a candidate alignment grid based on a connected subset of local structures, respective local structures recovered from the multiple fiducial dots and multiple data dots within the image.

14. The machine-readable storage medium as claimed in claim 13, further comprising instructions executable by the processor of the apparatus to cause the apparatus to:
generate a planar homography to map grid locations representing points of the candidate alignment grid to points on the alignment grid; and
recover a first representation of the alignment grid using the planar homography.

15. The machine-readable storage medium as claimed in claim 14, further comprising instructions executable by the processor of the apparatus to cause the apparatus to:
determine the presence of supporting grid points within the extended candidate alignment grid; and
refine the planar homography using the supporting grid points.
